(19) United States
(12) Patent Application Publication
(10) Pub. No.: US 2012/0130541 A1
(43) Pub. Date: May 24, 2012

(54) METHOD AND APPARATUS FOR ROBOT TEACHING

(76) Inventor: Leszek A. Szalek, Sunnyvale, CA (US)

(21) Appl. No.: 13/227,232

(22) Filed: Sep. 7, 2011

Related U.S. Application Data
(60) Provisional application No. 61/402,835, filed on Sep. 7, 2010.

(51) Int. Cl. B25J 9/16; B25J 19/02; B25J 9/06

(52) U.S. Cl. 700/258; 901/4; 901/46; 901/15

(57) ABSTRACT

A method and apparatus are disclosed for the direct and safe teaching of a robot. The apparatus consists of a plurality of tactile sensors and electronic circuitry encapsulated in a compact enclosure, and a handle protruding from the enclosure. The handle provides an easy means for an operator to apply an external force and to act on the sensors that generate electronic signals to the robot controller. The signals, proportional to the applied force, carry information that sets boundaries for safe operations, thus protecting the operator from any harm and the robot from damage.

While in the teaching mode the operator guides the robot with the apparatus to the predetermined work positions that are recorded in the controller memory. The work position recording can be handled by either activating a pushbutton or by a voice command. The recorded positions are played back when the robot operates in the work mode.

### FIELD OF THE INVENTION

The present invention relates generally to industrial robots and more particularly to a method and an apparatus for teaching robots work positions.

### BACKGROUND OF THE INVENTION

There are a number of methods and apparatus proposed to perform the robot teach-in operation. They take different approach considering the size of force needed to be applied, operator safety and fatigue during the operation proposing solutions of various complexity and advancement, solving the teaching problem at various completeness levels.

The proposed methods and devices present a number of shortcomings such as complexity, application limited to specific robot configuration, limited safety features or lack of them additionally increasing fatigue of the operator, to list a few.

In a first method, as disclosed in the U.S. Pat. No. 6,212,443, issued to H. Nagata et al., an apparatus with a force detector and a teaching tool is employed to minimize operator's fatigue and increase his safety. The unit can be arranged in several configurations allowing for direct and remote teaching. It provides two degrees of freedom, however, thus allowing for only two directions of motion, and teaching position or attitude at the time. The teaching moves require complicated motion models for modeling position and velocity, as well as viscosity and inertia and further computation devices for computing friction and gravity compensation torque, along with a device for changing torque limit. The final torque command is generated by a dedicated adder. All of this constitutes an elaborated motion model and requires other computation devices, complicating the robot's overall control scheme.

The manipulator is used by an operator to perform a function of a teaching terminal whereas the teaching tool is used for guiding the robot's wrist to working positions. Independent of the teaching tool location, whether on the robot or attached to the teaching manipulator, an operator is required to manipulate correct switches to toggle between various teaching modes. That teaching procedure demands operator's attention still causing excessive mental fatigue. It also demands from the operator to be alerted at all times, in case of being trapped between the robot's arm and the work, to turn power off using the emergency switch or to endure force and mental pressure until the compliance mechanism sends the turn off signal.

In a second method, as disclosed in the U.S. Pat. No. 6,385,508B1, issued to H. Dean McGee et al., the apparatus does not have inherently built-in safety measures to stop robot motion in case the handle of the teaching apparatus makes undesirable contact with the work and the robot is generating power in the direction of force. Even though the operator is not in dangerous circumstances, in this case, due to his distant position from the robot arm but it can cause work and robot damage before the dead-man switch is activated. Especially that both hands of the operator are engaged in holding the teaching apparatus. In addition, the magnetic attachable device limits its application only to robot arms or their components made of ferromagnetic materials.

In one of the most relevant prior art disclosures, for example, the U.S. Pat. No. 4,320,392, issued to G. Giovinazzo at al., the presented apparatus takes advantage of an electrical phenomenon such as capacitance to measure the applied force and moment. The disclosed invention requires dielectric fluid under pressure making this approach costly due to complex system of ducts within the parts, trouble of sealing and pressurized air supply. It does not provide safety means in case the handle of the teaching apparatus makes undesirable contact with the work and the robot is generating power in the direction of force, thus endangering the safety of the operator and causing potential work and robot damage.

Another approach for teaching robot can be found in the U.S. Pat. No. 4,408,286, issued to H. Kikuchi and K. Sugimoto, where the disclosed apparatus uses strain gauges to model forces and moments applied to its members. The invention presents several shortcomings. These sensors require calibrations and complicated electronics to process generated signals. To increase complexity of the invention even further, it applies extensive modeling for force and moment computations. Additionally, the invention requires converting forces and moments into absolute coordinate system further complicating the mathematical model inside the control unit at the same time introducing positioning errors. Stiffness of the apparatus members does not allow for fine adjustment of the position. In addition, the device is rigidly attached to the robot wrist making it difficult to use with different tool attachments. The disclosed invention requires a six-degree of freedom strain sensor, making it an expensive solution. The teaching method derived from this invention is not very intuitive due to complexity of the six-degree device. As such it makes difficult to control a robot in precise manner, thus not being practical for the teaching procedure.

In another disclosed U.S. Pat. No. 4,367,532, issued to G. W. Crum and B. M. Rooney, the force transducer is required to be located in series with the end of the robot arm and its wrist, thus creating a weak joint between the two. Additionally, this force transducer can be only used in robots with massive robot arm joints and lightweight wrist joints which can be manually moved without the need of power and assistance of additional devices, further limiting its application.

### SUMMARY OF THE INVENTION

The main object of the present invention is to provide a simple apparatus for direct teaching of a robot in safety and a method of teaching a robot, known in the art as a teach-in or guiding method, eliminating the prior art deficiencies and limitations.

To achieve the above object, in accordance with the present invention, an apparatus capable of sensing physical force is attached to a robot arm and its wrist, or just a wrist, depending on robot size, its kinematic configuration and the work performed.

The apparatus encapsulates tactile sensors generating electric signals proportional to applied force. It is a four degree of freedom device with a shaft, further referred as the handle, protruding from the casing and enabling an operator to apply force in three-dimensional space in the direction of each of the Cartesian XYZ axis and a rotary move about the center axis of the handle. The signals are processed inside electronic circuitry providing necessary information to the main controller to command the robot to desired work location and setting its wrist at desired work orientation.

The controller's command computes velocity directive proportional to applied force, however, never exceeding the velocity safe limit preset in the teaching mode of operation. The apparatus electronic circuitry outputs signal when force level exceeds certain minimum level, thus protecting from undesired, too sensitive robot moves and making the apparatus immune to significant temperature drift. It requires the operator to apply a certain amount of force to the handle to engage the tactile sensors in order to output signal at the level that generates move commands. If force exceeds certain maximum level, preset as an upper limit, the apparatus outputs signal of a value equal to that maximum level. The upper limit defines the danger zone when the handle becomes pushed too far. In case the handle of the teaching apparatus makes undesirable contact with the work and the robot is generating power in the direction of force, once the force level exceeds the upper limit, the safety signal is generated and input to the robot main controller to execute command bringing the robot to an immediate halt. It works as an emergency or a dead-man switch, inherently built into to the teaching apparatus. This feature does not require the operator to be alerted all the time and to quickly react when the robot moves into undesired zone. This feature becomes handy when the operator panics or is shocked, thus being mentally incapable to activate an external safety switch. In the final result, this built-in safety mechanism does not require the operator to hold the emergency switch and saves human life or health, significantly lowers operator's fatigue and prevents work damage. Besides, it eliminates a need of a compliance mechanism, making it a simple, cost effective device, especially, if inexpensive resistive force sensors are used.

Further, the apparatus comprises a pushbutton and a microphone to record the work position in the memory means by either pushing the button or pronouncing the designated voice command. The recorded work locations are played back when robot operates in the work mode.

It further comprises a switch to select between the arm or wrist teaching modes and used when the apparatus is attached only to the wrist. The apparatus is operated by a small amount of force applied to its handle, making possible to guide the robot arms without applying the force to the wrist itself, thus not affecting the wrist position. The teaching mode select switch commands the main controller to apply the appropriate computations for the selected mode. Again, the function of the switch can be duplicated by pronouncing the designated voice command.

Even further, the apparatus comprises a wired or wireless link to communicate with the main robot controller.

As noted above, a method of direct robot teaching the desired work trajectory is also disclosed.

Robot and wrist motion commands are generated in response to the force applied to the apparatus handle to power assist the operator in moving the robot arm. The robot arm moves are relative to the current position and last as long as the force is applied to the handle. The relative moves make the mathematical model of the teaching procedure very simple

The main robot controller provides means to switch to the teaching mode. Once in that mode the controller lowers level of the voltage supplied to servo amplifiers, setting a limit on maximum velocity of motors powering robot arms at the safe level. At the same time, a limit is set to motors current to restrict motors maximum torque level allowing only compensation of the gravity force acting upon the robot arms. These limits imposed by the main controller physically prevent the robot from making unexpected moves that would endanger life or health of the operator. Additionally, the teaching apparatus enables the teaching procedure to be performed within the safety limits.

Depending on robot kinematic configuration, the disclosed apparatus can be attached to a robot at various locations. In case of an orthogonal kinematic configuration, it can be attached at the end of the arm where the tool is fixed. In case of a five or six degree of freedom articulated robotic arm, it can be attached to the wrist or at the end of the arm by the wrist joint and to the wrist itself. The latter arrangement requires two devices to be used simultaneously for robot teaching. Placement of the teaching apparatus and the way of applying it for the robot teaching depends on the work the robot is designated to perform, whether the tool is attached or a work object is carried, and the robot configuration itself.

During the teaching procedure, the operator applies gentle force to the apparatus handle in the direction that guides the robot arm to the desired work location. Once at that location, the operator records arms position in the memory means either by pushing the record button or pronouncing the voice command whatever is more convenient.

The four degree of freedom apparatus provides a good selection of moves for an intuitive way of teaching a robot. For example, an orthogonal robot can utilize handle displacements in Cartesian coordinates corresponding directly to individual axes of the robot. In another, more complex example of a six degree robotic arm, the apparatus can be placed at the wrist for the purpose of teaching the robot work locations and wrist work orientation. In that case, using the mode switch or a voice command, the apparatus is switched to the robot arm teaching mode. While in that mode, the appropriate kinematic model is selected and applied to transform the Cartesian moves of the apparatus handle into angular moves of the robot joints. When switched to the wrist teaching mode, using the mode switch or the voice command, the appropriate kinematic model is selected and applied to transform the Cartesian and roll moves of the apparatus handle into angular moves of the wrist orientation.

The present invention will be better understood when reading the following description in conjunction with the accompanying drawings.

### BRIEF DESCRIPTION OF THE DRAWINGS

FIG. 1 is a perspective view of the teaching apparatus used in the direct teaching operation.

FIG. 2a is a view of the teaching apparatus attached to the end of a robot arm and its wrist, and used in the direct teaching operation.

FIG. 2b is a perspective view of a robot wrist and the teaching apparatus attached to it and to the end of a robot arm.

FIG. 3 is a block diagram which shows one embodiment of the teaching apparatus attached to a wrist of an articulated type robot arm.

FIG. 4 is a block diagram of the electronic circuit of the teaching apparatus.

FIG. 5a is a cut-away perspective view of the teaching apparatus.

FIG. 5b is a section view on line “5b-5b” of FIG. 5a.

FIGS. 6a-6d, and 7a-7b are sectional views of teaching apparatus in the operative positions.

FIG. 8 is a perspective view of the piston assembly with the handle of the teaching apparatus.

### DETAILED DESCRIPTION

The present invention will be described in detail based on the embodiments illustrated in the drawings. The embodiments of the present invention described below are not intended to be exhaustive or to limit the invention to the particular embodiments disclosed in the following detailed description. Rather, the embodiments are described so that others, particularly those skilled in the art may appreciate and understand the principles and practices of the invention.

To achieve this object, this invention provides a four degree of freedom apparatus implementing tactile sensors generating electrical signal corresponding to the force applied to the said sensors. The terms “tactile sensor” or “force sensor” as used herein, generally refer to a device having a touch sensitive surface that can detect contact with another tangible structure, object, entity, or the like. In particular, a touch sensitive surface can indicate not only that the surface is touched but also can provide information about the strength of force applied to the touch sensitive surface. Such force information can advantageously be used to determine the velocity of robot joints and to bring the robot to an immediate halt should the force value exceeded the set safe level. Such devices may comprise a single touch sensitive surface or may comprise plural touch sensitive surfaces or regions, which surfaces are preferably planar but may be non-planar or curved. These devices are generally known and the most common ones are elastoresistive sensors, which are presented in the invention.

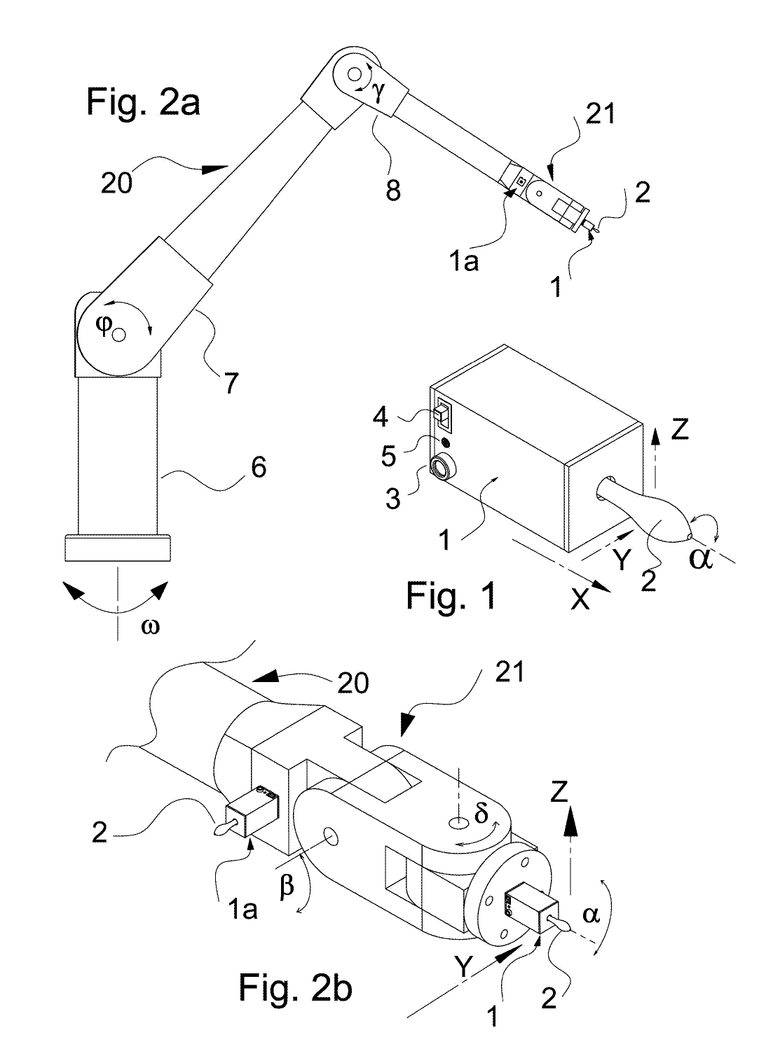

FIG. 1 is a perspective view of the 4 degree of freedom teaching apparatus 1 capable of sensing force applied to the handle 2. The handle can be moved in the Cartesian coordinates along the X, Y and Z axes, and rotated around its center in the Y-Z plane by angle α.

The casing of the apparatus encloses the tactile sensors that generate electric signals proportional to the force applied in the respective direction. The force signals, represented by electric current or voltage values are processed by the enclosed electronic circuit 17, which outputs them in the digital form. The force vector can be derived from its component vectors aligned with each Cartesian axis.

To fully assist the teaching procedure the apparatus comprises the switch 4 for setting the teaching mode and the pushbutton 3 for recording the working position of the robot arms or the working orientation of the wrist joints. As an alternative means to the pushbutton, a voice command can be applied using the built-in microphone 5 to perform the position recording in the memory means.

FIG. 2a is a view of the force joystick installed at the distal end of an articulated multi joint robot arm 20 and to the roll joint of the wrist 21. By applying the force to the handle of the apparatus la an operator can guide the arm end to a specific location in the robot working space. By applying the force to the handle 2 of the sensor 1 an operator can set the wrist at a desired orientation. The Cartesian axes of the apparatus can be assigned to respective robot joints depending on the robot kinematic configuration. In this example, the direction of the applied force acting in parallel to the apparatus X axis will cause the angular displacement ω of the robot waist joint. The direction of the applied force acting in parallel to the apparatus Z axis will cause the angular displacement φ of the robot shoulder joint, whereas the direction of the applied force acting in parallel to the apparatus Y axis will cause the angular displacement γ of the robot elbow joint.

FIG. 2b is a perspective view of the robot wrist 21 attached to the end of the robot arm 20. The apparatus 1a assists in teaching the robot work location, while the teaching apparatus 1 mounted to the roll joint of the wrist assists in teaching the wrist working orientation. In this example, the direction of the applied force acting in parallel to the apparatus Z axis will cause the angular displacement β of the wrist pitch joint. The direction of the applied force acting in parallel to the apparatus Y axis will cause the angular displacement δ of the wrist yaw joint, whereas the applied force acting rotationally about the center axis of the handle in parallel to the apparatus Y-Z plane will cause the angular displacement α of the wrist roll joint.

Depending on the robot configuration and the teaching procedure preference, only one apparatus can be used for the teaching both—the robot arm work position and the wrist work orientation. In that scenario, the apparatus 1 is attached only to the roll joint of the wrist. The operator is required to toggle between the teaching modes to either teach the robot or the wrist using the switch 4 or a voice command utilizing the built-in microphone 5.

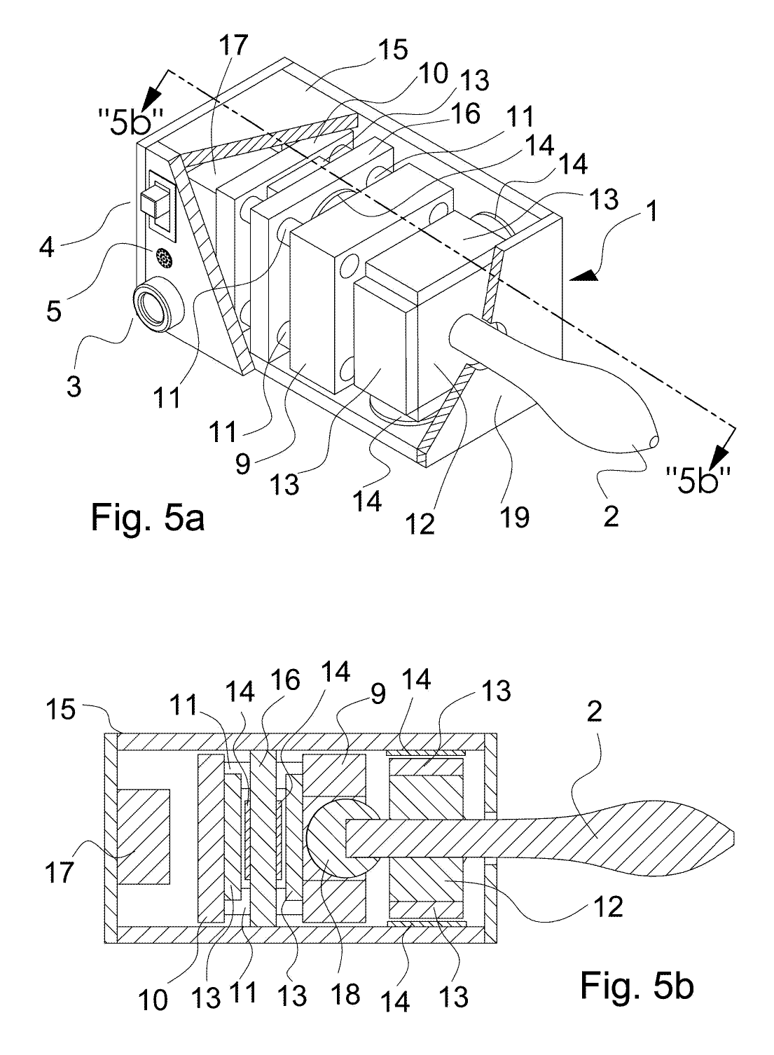

As illustrated in FIG. 5a and FIG. 5b, the said apparatus 1 comprises a rigid casing 15 encapsulating a solid object 12 of a cuboid, known as a regular hexahedron or a box. The solid object 12 is further referred as the core. The core 12, made of rigid lightweight material to minimize gravitational force acting on a sensor, has a shaft driving perpendicularly through its center. At one end, the handle 2, serving as a reaction member, protrudes with some clearance through a centrally-located circular opening in the casing front wall 19. At the other end, the handle 2 is terminated with a spherical ball 18. The ball is seated inside a spherical cavity of the object 9 providing a swivel joint between the ball and the cavity enabling movement of the handle 2 along with the core 12 about the ball in any direction, including rotation, in respect to the object 9. The handle 2 can be displaced along the Y and Z axes and rotated about its center axis in the Y-Z plane, as shown in FIG. 1, thus allowing for three degree of freedom movements of the core 12, limited only by the inner walls of the casing 15. The cavity of the ball joint assembly is situated in the center of the solid object 9 being of a regular box shape, which is connected by a plurality of shafts 11 with yet another solid object 10 of the same shape and size but thinner. The size of the solid objects permits fitting them with some clearance inside the inner facets of the casing 15. The two solid objects, joined together by the shafts 11, form a rigid structure 22, shown in detail in FIG. 8, further referred as the piston. Each shaft freely drives through an opening within the wall 16 and serves as a linear motion guide, allowing for yet another degree of freedom. The fixed Wall 16 is situated perpendicularly to the casing walls. When the force is applied to the handle 2 along its centric axis it generates a linear move of the core 12 and the piston 22 along the X axis, as shown in FIG. 1.

Linear move of the piston 22 is restricted by the fixed wall 16 located in-between the two solid members of the piston. Two external pairs of the core 12 facets and the inner facets of the piston members 9 and 10 are provided with pads 13 made of elastic material such as soft rubber, or a certain type of foam, or alike. The material presents spring like properties. Two pairs of the casing inner facets and the both sides of the fixed wall are provided with tactile sensors 14 facing each pad 13. When the force is applied to the handle 2, the pads 13 pressure tactile sensors 14 in respect to the direction of the force, thus generating signals proportional to the applied force. Upon releasing the force applied to the handle 2, the spring pads return the core 12 and/or the piston 22 to their neutral position, bringing sensors signals to their minimum level.

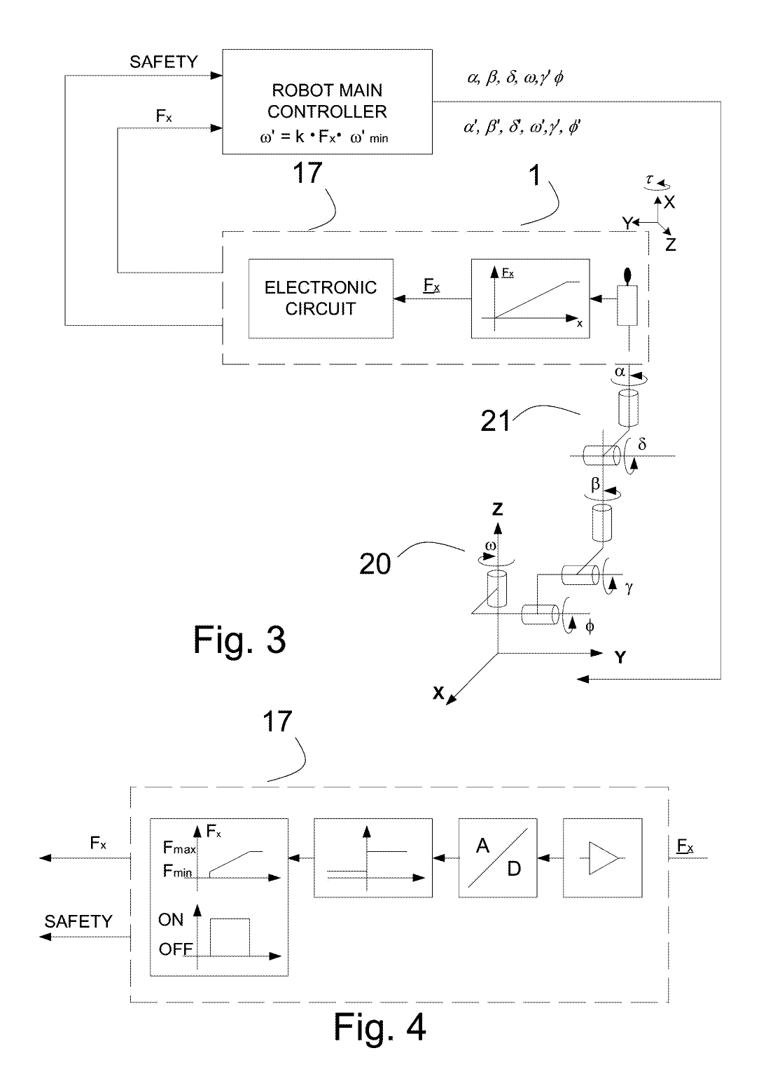

A schematic circuit diagram of a six degree of freedom articulated type robot, as known in the art, is shown in FIG. 3. It illustrates a flow of the signal from the tactile sensors of the apparatus 1 to the main robot controller that generates move commands to the robot during the teaching operation. In the illustrated example, the apparatus 1 is attached to the wrist 21 of the robot arm 20. The tactile sensors 14 of the apparatus 1 generate the electric signals Fₓ, in a form of electric current or voltage, proportional to the applied force. In this case, the Fₓ value represents the signal of the sensor along the X axis, however, the same principle applies to all the sensors. The output signals from the sensors are processed in the electronic circuit 17 enclosed inside the apparatus, as shown in detail in FIG. 4. The electric signals representing applied force may be amplified and sampled at given time intervals. The sampled signals are converted into digital signals by analog-to-digital (A/D) converters and then computed by the circuit processing unit in accordance with the below formula:

Fₓ=0 if Fₓ<=Fₘᵢₙ (1)

if Fₓ=Fₓ if Fₓ>Fₘᵢₙ and F<=Fₘₐₓ (2)

Fₓ=Fₘₐₓ if Fₓ>Fₘₐₓ (3)

where, Fₘᵢₙ defines the lower boundary of the force value, while Fₘₐₓ defines the upper boundary of the force value. Fₓ is a force signal generated by a tactile sensor.

The preset minimum force value Fₘᵢₙ defines lower boundary of the signal Fₓ, thus reducing sensitivity of the apparatus. The apparatus generates force signal greater than zero only when certain force is applied to its handle, thus making it immune to a small amount of force like in the situation when the bottom pad 13 touches the sensor surface under the gravity force.

The force signal Fₓ is remotely transmitted to the main robot controller via wired or wireless means. The controller command computes velocity directive proportional to the applied force in accordance with the below formula:

ω′=k·Fₓ·ω′ₘᵢₙ (4)

where ω′ₘᵢₙ is a minimum angular velocity of the robot waist joint set for the teaching procedure, while k is a constant, and Fₓ is a value corresponding to the applied force. When no force is applied or the force value is does not exceed the Fₘᵢₙ value, the velocity value equals zero setting the robot joint at rest. As long as the force value Fₓ stays within the boundaries respective robot or wrist joints stay in motion, causing the robot joint to be displaced by an angular value ω in the direction corresponding to the direction of the applied force and the amount proportional to it.

In addition to processing the force signal Fₓ, the electronic circuit 17 works also as a watchdog device, as known in the art. When the force signal Fₓ exceeds the preset maximum value Fₘₐₓ, it automatically generates the safety signal to the main robot controller to command the robot moves to halt. The signal works as an emergency switch signal, in case the handle of the teaching apparatus makes undesirable contact with the work and the robot is generating power in the direction of force

The operation of the apparatus will now be described.

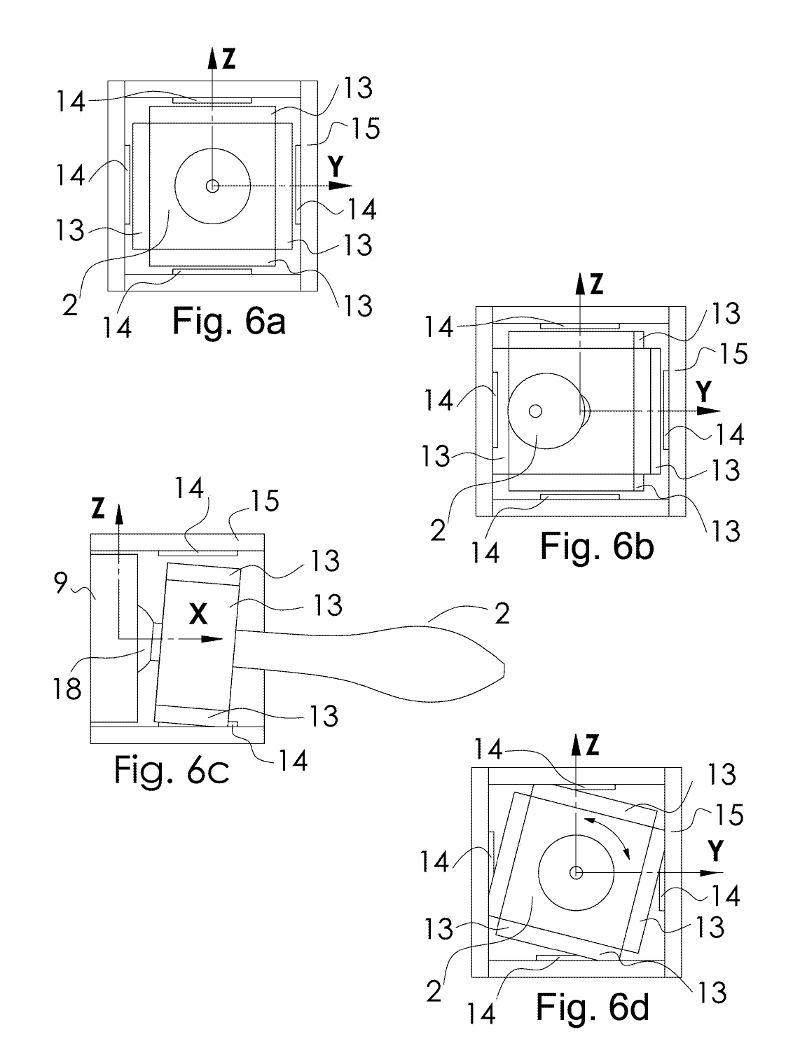

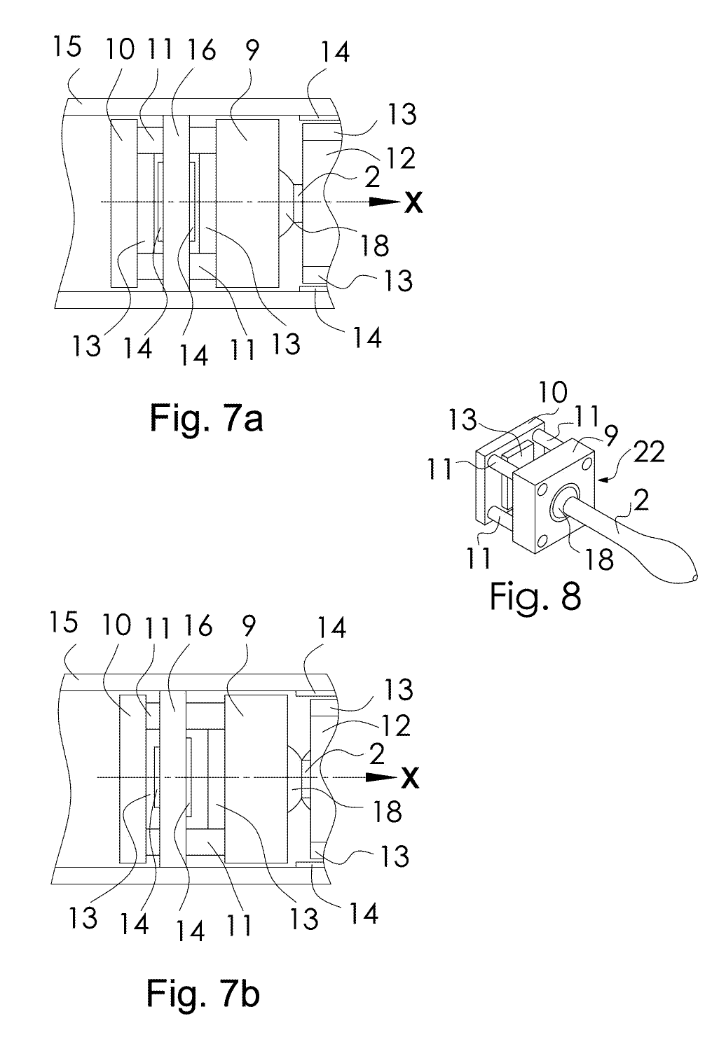

From the force signals F a vector showing the direction or nature of the move can be derived, as illustrated in FIGS. 6a-6d, and FIGS. 7a and 7b.

FIG. 6a shows the relative position of the core element 12, in case no force is applied to the handle 2. In this condition all the pads 13 are equidistant from the sensors 14, in the distance defined by the thickness of the pads. A small gap between the pads 13 and sensors 14 is shown to illustrate and explain the operation more clearly. In this example, the force signal generated by the apparatus equals to zero.

FIG. 6b shows the position assumed by the core 12 relative to the pair of tactile sensors 14 placed on the vertical facets of the casing 15 as a force has been linearly applied along the Y axis tilting the handle 2 to the left. In this condition, the pad 13 located on the left facet of the core element 12 applies pressure to the respective sensor 14, thus generating an electric signal corresponding to a component vector −F_{y} and indicating a direction of the applied force parallel to the coordinate axis Y.

FIG. 6c shows the position assumed by the core 12 relative to the pair of tactile sensors 14 placed on the horizontal facets of the casing 15 as a force has been linearly applied along the Z axis tilting downward the handle 2. In this condition, the pad 13 located on the bottom facet of the core element 12 applies pressure to the respective sensor 14, thus generating an electric signal corresponding to a component vector −F_{z} and indicating a direction of the applied force parallel to the coordinate axis Z.

FIG. 6d shows the position assumed by the core 12 relative to all tactile sensors 14 placed on the facets of the casing 15 as a rotational force has been applied to the handle 2 about the X axis. In this condition, the pads 13 located on all the facets of the core element 12 apply simultaneously pressure to the respective sensors 14, thus generating electric signals corresponding to component vectors −F_{y}, F_{y}, −F_{z} and F_{z} and indicating a rotational force applied parallel to the Y-Z plane.

Similarly, FIGS. 7a and 7b illustrate force applied to the handle along the X axis. FIG. 7a illustrates the relative position of the piston 22, in case no force is applied to the handle 2. In this condition, the two pads 13 located respectively on the piston element 9 and the piston element 10 are equidistant from the respective sensors 14 attached to the fixed wall 16. In this example, the force signal generated by the apparatus equals to zero.

FIG. 7b illustrates the position assumed by the piston 22 relative to the pair of the tactile sensors 14 placed on the opposite facets of the wall 16 as a force has been linearly applied along the X axis by pulling forward the handle 2. In this condition, the pad 13 located on the piston element 10 applies pressure to the respective sensor 14, thus generating an electric signal corresponding to a component vector F_{X} and indicating a direction of the applied force parallel to the coordinate axis X.

Compound moves of the handle are possible along any Cartesian axis, thus allowing for simultaneous move of multiple robot or wrist joints.

As illustrated above and according to the presented embodiment, it becomes possible to use the apparatus for teaching robots of different kinematic configurations. Small size and effortless operation allow applying the apparatus to robots of various sizes and placing it at applicable parts of the robot. The most preferred location it seems to be the robot wrist, allowing to direct the robot arm and to orient the wrist at the desired work position from a single apparatus location. The recording procedure and changing the operation modes can be conveniently performed by the use of voice commands. Additionally, the inherent procedure of generating the safety signal to the main robot controller makes it extremely safe to use, thus practically eliminating operator fatigue from the direct teaching process. Finally, the simple mechanical structure and integrated functionality make the device easy to use and inexpensive to produce.

Various modifications to the presented apparatus are possible, thus, for example, the piston assembly can be eliminated by using two hollow tactile sensors fixed to the vertical facets of the core element 12. A hole instead of a spherical cavity drilled in the center of the element 9 can enable a linear displacement of the ball 18 along the X axis. Fixing the element 9 to the casing walls with one of the sensors attached to its front facet and the other sensor attached to the inner facet of the front wall 19 of the casing 15 with appropriately placed hollow pads on the two remaining facets of the core 12 provide a different structure for the movement along the X axis.

It is to be understood, however, that while particular forms or embodiments of the invention have been illustrated, further modifications, including modifications to shape, and arrangement of parts, and the like, can be made without departing from the spirit and scope of the invention.

I claim:

1. A method for direct teaching of a robot, comprising a plurality of arms and a wrist movably linked to a distal end of an arm of the robot, and of corresponding actuators for displacing them in a plurality of directions, comprising the steps of:
a. switching the robot main controller to the teaching mode to execute the teaching procedure and applying an external force to the tactile sensors of the apparatus attached to the wrist in the direction desired for the purpose of the teaching,
b. processing the sensor signals and generating force values within preset boundaries for the purpose of computation of the corresponding velocity directives causing the actuators to displace the robot joints in the direction of the applied force moving the robot arms to work locations for as long as the force is applied,
c. recording the teaching data, in the form of position information, using the means of a pushbutton,

2. A method according to claim 1, wherein switching between the teaching modes to either displacing the robot arm joints or the wrist joints is performed using the means of a switch.

3. A method according to claim 1, wherein the teaching apparatus is also attached at the distal end of the robot arm.

4. A method according to claim 2, wherein recording of the teaching data, in the form of position information, and switching between the teaching modes is performed using the means of a voice command.

5. A method according to claim 3, wherein recording of the teaching data, in the form of position information, is performed using the means of a voice command.

6. A direct teaching apparatus with four degrees of freedom structured to generate electric signals indicative of forces applied to a movable member which applies pressure to plurality of tactile sensors in the direction of the applied forces, comprising:
a) a rigid casing in the form of a rectangular tubing of which inner walls have two pairs of tactile sensors attached to their surface;
b) a shaft protruding with clearance through a circular opening in the casing front wall, that is driven through a solid body in the form of a cuboid with pads made of elastic material of spring like properties, the said pads being attached to the facets of the solid body facing the tactile sensors placed on the inner facets of the casing;
c) an inner wall fixed inside the casing with plurality of holes for driving shafts; the wall having a pair of tactile sensors attached to the opposite facets of the wall;
d) a piston like sub-assembly comprising a pair of cuboid members connected together by a plurality of shafts; the shafts are driven through the holes inside the inner wall thus permitting the linear moves; the cuboid members having a pair of the elastic pads fixed to the facets facing each other;
e) a spherical ball fixed at the end of the shaft and seated in a spherical cavity inside one of the piston members, providing a swivel joint between the ball and the cavity enabling movement of the shaft about the ball in any direction;
f) a pushbutton for the purpose of recording the work position information in the memory means;
g) a switch for the purpose of setting the teaching mode;
h) a microphone as an alternative means to switch between the teaching modes and to record the work position information in the memory means by using the designated voice commands;
i) the electronic circuit processing the tactile sensors force signal from the form of electric current or voltage to the digital form; the circuit setting the boundaries to the force value to define the level of sensitivity and to eliminate temperature drift at the lower limit, and limiting excessive force at the upper limit; the circuit generating a safety signal to halt robot moves in case of the exceeding maximum limit of the force;
j) the wireless or wired means for remotely transmitting the force information to the main controller;

7. The apparatus according to claim 6, providing the means of a microphone to execute voice commands for the purpose of switching between the teaching modes and recording the work position information in the memory means.
